(19) United States
(12) Patent Application Publication
(10) Pub. No.: US 2026/0296937 A1
(43) Pub. Date: Oct. 1, 2026

(54) FIXED FILM BIOREACTOR FOR PURIFICATION OF WATER AND ASSOCIATED METHODS

(71) Applicant: WesTech Engineering, LLC, Salt Lake City, UT (US)

(72) Inventors: Aleksandra Opara, Salt Lake City, UT (US); Bryce David Myers, Syracuse, UT (US); John Patrick Bowden, West Valley City, UT (US); James Alan Judd, West Jordan, UT (US)

(73) Assignee: WesTech Engineering, LLC, Salt Lake City, UT (US)

(21) Appl. No.: 19/097,628

(22) Filed: Apr. 1, 2025

(51) Int. Cl. C02F 3/28; C02F 3/00

(52) U.S. Cl. CPC C02F 3/2873; C02F 3/2806; C02F 2003/003; C02F 2203/006; C02F 2303/16

(57) ABSTRACT

An improved fixed film bioreactor for the purification of water is disclosed. The bioreactor may include an eductor disposed at least partially within a convergence region of a tank. The bioreactor may also include a lift conduit for receiving pressurized water and media components from the eductor. A media cleaning pathway may include the lift conduit and the eductor. The water purification process of the bioreactor may continue in an uninterrupted manner during a media cleaning cycle, which utilizes the media cleaning pathway. Associated methods are also disclosed.

### TECHNICAL FIELD

The present invention relates generally to bioreactors for purification of water. More specifically, the present invention relates to an improved bioreactor for purification of water and related methods.

### BACKGROUND

Bioreactors use microbes to assist in the purification of water. The microbes form a biofilm on media disposed within a bioreactor. Periodically, the media needs to be cleaned. This cleaning process, in conventional bioreactors, can be damaging to the biofilm and also requires a temporary disruption of the water cleaning process of the bioreactor. In conventional systems, high-pressure air or water is often utilized in the cleaning process. Conventional systems often require a recovery time after the media cleaning process before satisfactory performance can be achieved by the bioreactor. This is particularly true where high-pressure air is utilized as part of the media cleaning process because the air introduced during the media cleaning process inhibits the anaerobic and anoxic microbial processes (when anaerobic and anoxic microbes are used), further impairing optimal operation of the bioreactor. Therefore, an improved bioreactor that addresses one or more of the foregoing concerns is desirable.

### SUMMARY

The following is a brief overview of the subject matter at issue and is in no way limiting of that subject matter at issue.

Potential embodiments of a bioreactor and a method of operating the bioreactor are disclosed. This summary provides only sample embodiments of the bioreactor and the method of operating the bioreactor and are, therefore, not limiting of the disclosed subject matter.

A first set of embodiments of a bioreactor for the purification of water is disclosed. One or more of the first set of embodiments of the bioreactor may comprise an anaerobic/anoxic fixed film bioreactor with the bioreactor configured to provide media cleaning.

One or more of the first set of embodiments of the bioreactor may comprise a tank comprising a convergence end and a remote end. When the bioreactor is in an installed configuration, the convergence end may be disposed closer to an influencing gravitational source than the remote end. The tank may comprise a convergence region disposed at the convergence end.

One or more of the first set of embodiments of the bioreactor may further comprise a water influent system comprising at least one distribution header for introducing water to be purified into the tank. The at least one distribution header may be disposed closer to the convergence end than the remote.

One or more of the first set of embodiments of the bioreactor may further comprise media components that may be disposed within the tank. Each of the media components may comprise at least one surface to which a biofilm for purification of the water may adhere.

One or more of the first set of embodiments of the bioreactor may further comprise an eductor disposed at least partially within the convergence region. The eductor may comprise an input opening, an output opening, an eductor flow pathway, one or more lateral openings, and a narrowed region disposed within the eductor flow pathway between the lateral openings and the output opening. The input opening and the output opening may be disposed at opposite ends of the eductor flow pathway with the input opening, the output opening, the eductor flow pathway and the lateral openings in fluid communication with each other. The lateral openings may be disposed intermediate the input opening and the narrowed region along the eductor flow pathway. The one or more lateral openings, the narrowed region, and the output opening may be of sufficient size to allow the water and the media components to pass therethrough.

One or more of the first set of embodiments of the bioreactor may further comprise a pressurized water conduit positioned to provide pressurized water into the input opening of the eductor.

One or more of the first set of embodiments of the bioreactor may further comprise lift conduit having an entry opening, an exit opening and a lift conduit pathway placing the entry opening and exit opening in fluid communication with each other. The entry opening may be disposed to receive the pressurized water and the media components exiting from the output opening of the eductor. A media cleaning pathway may extend from the one or more lateral openings, along the eductor flow pathway, through the output opening, into the entry opening, through the lift conduit pathway, and to the exit opening of the lift conduit.

One or more of the first set of embodiments of the bioreactor may further comprise a pressurized water mechanism configured to provide the pressurized water via the pressurized water conduit to the eductor at a flow rate sufficient to induce one or more of the media components through the media cleaning pathway and to separate solids and gases from the media components disposed within the media cleaning pathway without fluidizing the media components outside of the media cleaning pathway during a media cleaning cycle of the bioreactor. A water purification process of the bioreactor may continue through at least a portion of the media cleaning cycle of the bioreactor.

In one or more of the first set of embodiments of the bioreactor, pressurized air is not injected into the tank during the media cleaning cycle of the bioreactor.

Within one or more of the first set of embodiments of the bioreactor, the flow rate may be greater than or equal to 1 gallon per minute and less than or equal to 60 gallons per minute.

Within one or more of the first set of embodiments of the bioreactor, the flow rate may be greater than or equal to 0.1 gallons per minute and less than or equal to 1.5 gallons per minute per square foot of surface area of the media components in the tank.

Within one or more of the first set of embodiments of the bioreactor, an inner diameter of the lift conduit may be greater than or equal to 1 inch and less than or equal to 6 inches.

Within one or more of the first set of embodiments of the bioreactor, the eductor may comprise a constricting nozzle disposed between the input opening and the narrowed region.

Within one or more of the first set of embodiments of the bioreactor, there may be a gap between the eductor and the lift conduit. The gap may be sufficiently large to allow the media components to pass through the gap and into the entry opening of the lift conduit. The gap may comprise a portion of the media cleaning pathway.

Within one or more of the first set of embodiments of the bioreactor, the media components are selected from a group consisting of activated carbon and small grain sand.

A second set of embodiments of a fixed film bioreactor for purification of water is also disclosed. Within one or more of the second set of embodiments of the bioreactor may be configured to provide media cleaning.

One or more of the second set of embodiments of the bioreactor may further comprise a tank comprising a convergence end and a remote end. When the bioreactor is in an installed configuration, the convergence end may be disposed closer to an influencing gravitational source than the remote end. The tank may comprise a convergence region disposed at the convergence end.

One or more of the second set of embodiments of the bioreactor may further comprise media components disposed within the tank. Each of the media components may comprise at least one surface for receiving a biofilm for purification of the water.

One or more of the second set of embodiments of the bioreactor may further comprise an eductor disposed at least partially within the convergence region. The eductor may comprise an input opening, an output opening, an eductor flow pathway, one or more lateral openings, and a narrowed region disposed within the eductor flow pathway between the lateral openings and the output opening. The input opening and the output opening may be disposed at opposite ends of the eductor flow pathway with the input opening, the output opening, the eductor flow pathway and the lateral openings in fluid communication with each other. The lateral openings may be disposed intermediate the input opening and the narrowed region along the eductor flow pathway. The one or more lateral openings, the narrowed region, and the output opening may be of sufficient size to allow the water and the media components to pass therethrough.

One or more of the second set of embodiments of the bioreactor may further comprise a pressurized water conduit positioned to provide pressurized water into the input opening of the eductor.

One or more of the second set of embodiments of the bioreactor may further comprise a lift conduit having an entry opening, an exit opening and a lift conduit pathway placing the entry opening and exit opening in fluid communication with each other. The entry opening may be disposed to receive the pressurized water and media components exiting from the output opening of the eductor. A media cleaning pathway may extend from the one or more lateral openings, along the eductor flow pathway, through the output opening, into the entry opening, through the lift conduit pathway, and to the exit opening of the lift conduit.

One or more of the second set of embodiments of the bioreactor may further comprise a pressurized water mechanism configured to provide the pressurized water via the pressurized water conduit to the eductor at a flow rate sufficient to induce one or more of the media components through the media cleaning pathway and separate solids and gases from the media components disposed within the media cleaning pathway without fluidizing the media components outside of the media cleaning pathway during a media cleaning cycle of the bioreactor. A water purification process of the bioreactor may continue through at least a portion of the media cleaning cycle of the bioreactor.

In one or more of the second set of embodiments of the bioreactor, pressurized air is not injected into the tank during the media cleaning cycle of the bioreactor.

Within one or more of the second set of embodiments of the bioreactor, the flow rate may be greater than or equal to 1 gallon per minute and less than or equal to 60 gallons per minute.

Within one or more of the second set of embodiments of the bioreactor, the flow rate may be greater than or equal to 0.1 gallons per minute and less than or equal to 1.5 gallons per minute per square foot of surface area of media components in the tank.

Within one or more of the second set of embodiments of the bioreactor, an inner diameter of the lift conduit may be greater than or equal to 1 inch and less than or equal to 6 inches.

Within one or more of the second set of embodiments of the bioreactor, there may be a gap between the eductor and the lift conduit. The gap may be sufficiently large to allow the media components to pass through the gap and into the entry opening of the lift conduit. The gap may comprise a portion of the media cleaning pathway.

A set of embodiments of a method of operating a fixed film bioreactor for purification of water is also disclosed. The bioreactor utilized in connection with one or more of the set of embodiments of method may comprise a tank comprising a remote end and a convergence region. The bioreactor utilized in connection with one or more of the set of embodiments of the method may further comprise media components disposed within the tank with each media component comprising at least one surface for receiving a biofilm for purification of the water. The bioreactor utilized in connection with one or more of the set of embodiments of the method may further comprise an eductor disposed at least partially within the convergence region and a lift conduit configured to receive pressurized water and media components from the eductor. The bioreactor utilized in connection with one or more of the set of embodiments of the method may further comprise a media cleaning pathway extending through at least a portion of the eductor and through the lift conduit. The bioreactor utilized in connection with one or more of the set of embodiments of the method may further comprise a pressurized water mechanism configured to provide pressurized water to the eductor.

One or more of the set of embodiments of the method may comprise commencing a water purification process of the bioreactor prior to a media cleaning cycle.

One or more of the set of embodiments of the method may further comprise conducting the media cleaning cycle of the bioreactor by providing pressurized water to the eductor using the pressurized water mechanism at a flow rate sufficient to induce one or more of the media components through the media cleaning pathway and to separate solids and gases from the media components disposed within the media cleaning pathway without fluidizing the media components outside of the media cleaning pathway. In one or more of the set of embodiments of the method, pressurized air is not injected into the tank during the media cleaning cycle of the bioreactor.

One or more of the set of embodiments of the method may further comprise continuing the water purification process of the bioreactor through at least a portion of the media cleaning cycle.

Within one or more of the set of embodiments of the method, the flow rate may be greater than or equal to 1 gallon per minute and less than or equal to 60 gallons per minute.

Within one or more of the set of embodiments of the method, the flow rate may be greater than or equal to 0.1 gallons per minute and less than or equal to 1.5 gallons per minute per square foot of surface area of the media components in the tank.

Within one or more of the set of embodiments of the method, an inner diameter of the lift conduit may be greater than or equal to 1 inch and less than or equal to 6 inches.

Within one or more of the set of embodiments of the method, there may be a gap between the eductor and the lift conduit, wherein the gap may be sufficiently large to allow the media components to pass through the gap and into an entry opening of the lift conduit, the gap comprising a portion of the media cleaning pathway.

Within one or more of the set of embodiments of the method, the media components may be selected from a group consisting of activated carbon and small grain sand.

### BRIEF DESCRIPTION OF THE DRAWINGS

Illustrative embodiments of the invention will become more fully apparent from the following description and appended claims, taken in conjunction with the accompanying drawings. Understanding that these drawings depict only illustrative embodiments and are, therefore, not to be considered limiting of the invention’s scope, the illustrative embodiments of the invention will be described with additional specificity and detail through use of the accompanying drawings in which:

FIG. 1 is a side view of one embodiment of a bioreactor disposed on an influencing gravitational source;

FIG. 2 is a cross-sectional view of the bioreactor of FIG. 1 with a pressurized water source omitted;

FIG. 3 is an enlarged view of region 3 of FIG. 2;

FIG. 4 is an enlarged view of region 4 of the bioreactor depicted in FIG. 2;

FIG. 5 is a top view of a portion of a bioreactor shown in FIG. 2 with certain portions omitted to better illustrate surface area of the media components disposed within a tank of the bioreactor;

FIG. 6 is a bottom perspective view of one embodiment of an eductor that may be utilized in connection with a bioreactor;

FIG. 7 is a side cross-sectional view of the eductor of FIG. 6; and

FIG. 8 is a flow diagram illustrating one method of operating a bioreactor.

### DETAILED DESCRIPTION

Various aspects of the present disclosure are described below. It should be apparent that the teachings herein may be embodied in a wide variety of forms and that any specific structure, function, or both disclosed herein is merely representative. Based on the teachings herein, one skilled in the art should appreciate that an aspect disclosed herein may be implemented independently of any other aspects and that two or more of these aspects may be combined in various ways, even if that combination is not specifically illustrated in the figures or disclosed in the description. For example, an apparatus may be implemented, or a method may be practiced, using any number of the aspects set forth herein, whether disclosed in connection with a method or an apparatus. Further, the disclosed apparatuses and methods may be practiced using structures or functionality known to one of skill in the art at the time of filing, although not specifically disclosed within the application.

### DEFINITIONS AND TERMINOLOGY

This section provides introductory definitions for terms used in this application. Additional definitions may appear within the context of figure-specific discussions. The term “exemplary,” as used herein, denotes an example, implementation, or aspect of the disclosed subject matter without indicating preference for any particular implementation.

Ordinal terms such as “first” or “second” are provided for identification and ease of reference. They do not necessarily imply physical characteristics or ordering unless explicitly stated. Therefore, this terminology distinguishes elements with similar names, such as “first element” and “second element,” rather than indicating priority or sequence.

Indefinite articles like “a” and “an” signify “one or more” rather than “one.”

When describing a structure or operation that “comprises” or “includes” an element, additional elements not explicitly mentioned may also be included. Therefore, the terms “including,” “comprising,” and “having” should be understood as “including but not limited to” unless expressly stated otherwise. Similarly, an operation described as occurring “based on” a condition or event may also depend on other conditions or events not explicitly mentioned.

The terms “an embodiment,” “one embodiment,” or “another embodiment” do not refer to a single variation of the disclosed subject matter. Instead, they indicate that multiple variations may be applied to different implementations.

A “set” may include one or more of each item coming within the specified “set.” Therefore, unless otherwise explicitly specified a set may include a single item or a plurality of items.

An enumerated list of items in connection with an embodiment does not imply exclusivity or inclusivity unless specifically stated otherwise.

### RELATIONSHIP AND ATTACHMENT TERMINOLOGY

The phrases “secured to,” “connected to,” “coupled to,” and “in communication with” refer to any interaction between entities, including mechanical, electrical, magnetic, electromagnetic, or thermal interactions, as well as fluid communication. “Attached to” refers to mechanical coupling that restricts relative translation or rotation, while “pivotally attached to” and “slidably attached to” allow relative rotation or translation, respectively.

The phrase “attached directly to” indicates attachment with direct contact or separation by a single fastener, adhesive, or similar mechanism. The term “abut” denotes items in direct physical contact, whether attached, fused, or welded.

“Integrally formed” describes items manufactured as a single piece without requiring assembly. Conversely, “separately manufactured” indicates items that are not integrally formed, whether by different processes, or at different times or locations.

### ALIGNMENT AND POSITIONING TERMINOLOGY

The term “substantially coaxially aligned” indicates that two items share a common imaginary axis or are within 15° of sharing a common imaginary axis. The items may be spaced apart along this axis.

The term “offset and substantially coaxially aligned” refers to items sharing a common imaginary axis, with their center points spaced apart along this common imaginary axis.

“Overlapping and substantially coaxially aligned” refers to items that overlap along a common imaginary axis while remaining aligned.

“Coextensive and substantially coaxially aligned” describes items sharing a common axis and extending over the same distance along the axis.

“Center point nonalignment” signifies that the center points of each of the two identified items are not aligned along a designated axis.

“Center point alignment” signifies that the center points of each of the two identified items are aligned along at least one designated axis or prospective (e.g., from a top view or a side view).

“Outer boundary nonalignment” refers to items whose outer boundaries are not aligned along a designated axis. “Nonaligned positions” indicates that two items are not aligned along at least one axis, covering both center point and outer boundary nonalignment.

The term “generally” indicates an orientation or value within 10° of the specified angle, while “substantially” indicates a value within 10% of the specified value. Therefore, for example, “generally parallel” indicates components are within 10° of being perfectly parallel, and “generally perpendicular” indicates that the identified components are within 10° of being perfectly perpendicular.

### REFERENCE NUMERALS IN THE FIGURES

While certain components may appear multiple times in a drawing, not all instances will be labeled with the reference numeral to preserve the clarity of the figures. Where only one instance of a specific item presented repeatedly in the figures is referenced, the associated description will specifically refer to the instance at issue.

### GROUPING OF FIGURES

Based on the headings provided below, certain figures will be discussed as a group. The part names and reference numerals discussed in such a group will not necessarily appear in all of the figures in the group but will appear in at least one figure within the group of figures simultaneously discussed.

### INTRODUCTION

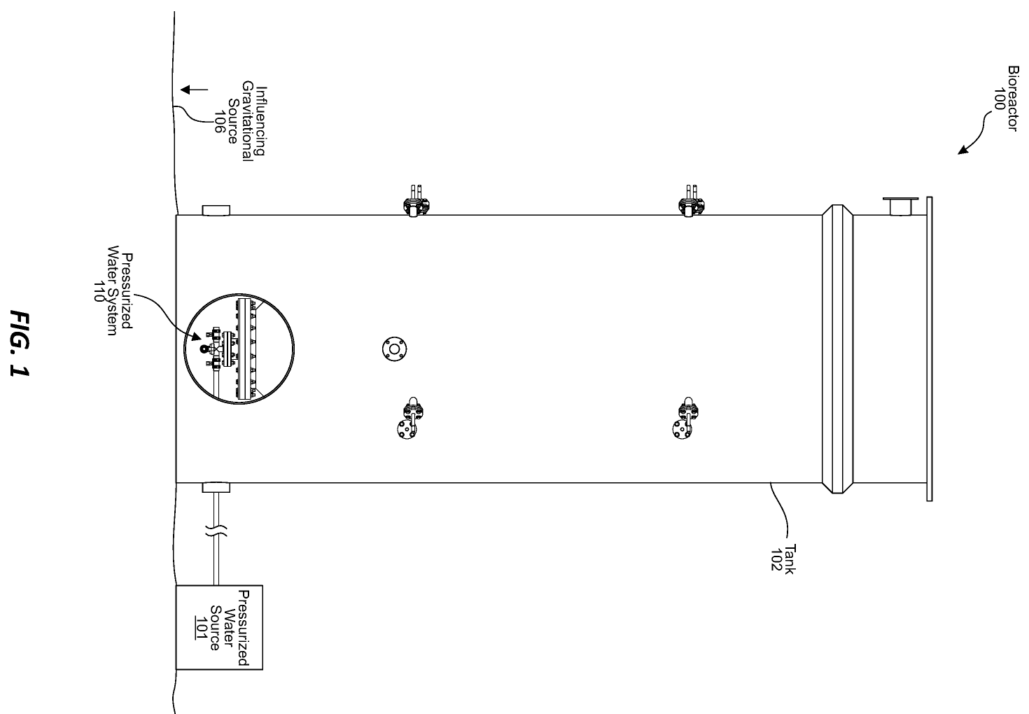

FIGS. 1-7 illustrate one embodiment of the bioreactor 100, which includes one or more improved features relative to conventional systems or methods. FIG. 8 illustrates a method of operating a bioreactor 100. Within the figures, certain components have been omitted or simplified, such as baffles or weirs, to better illustrate remaining components of the bioreactor 100.

Description of FIGS. 1 TO 7

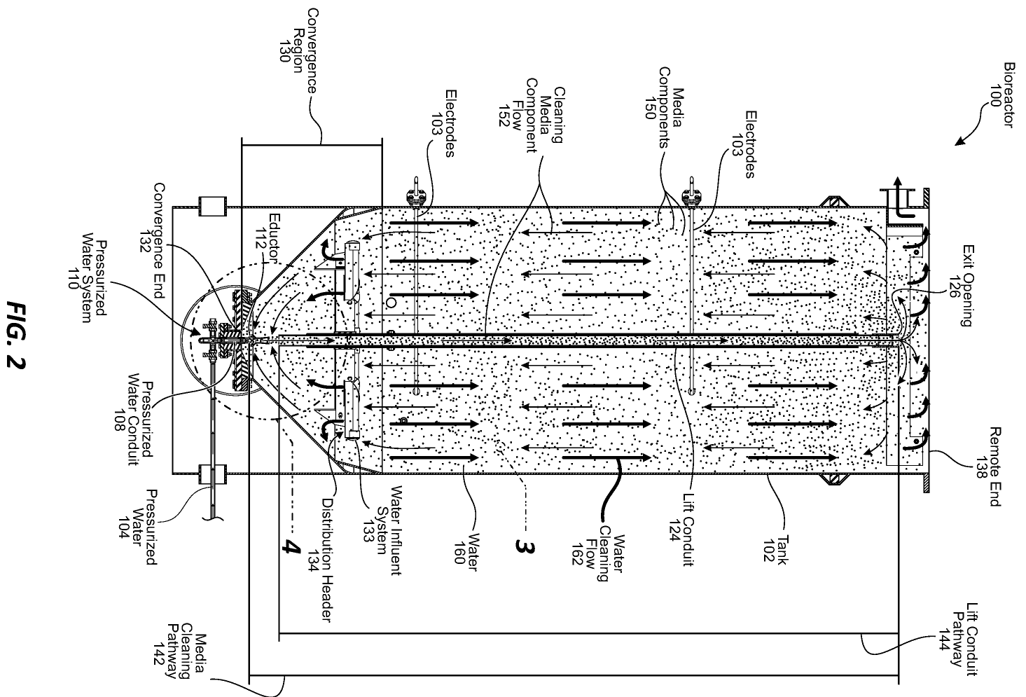

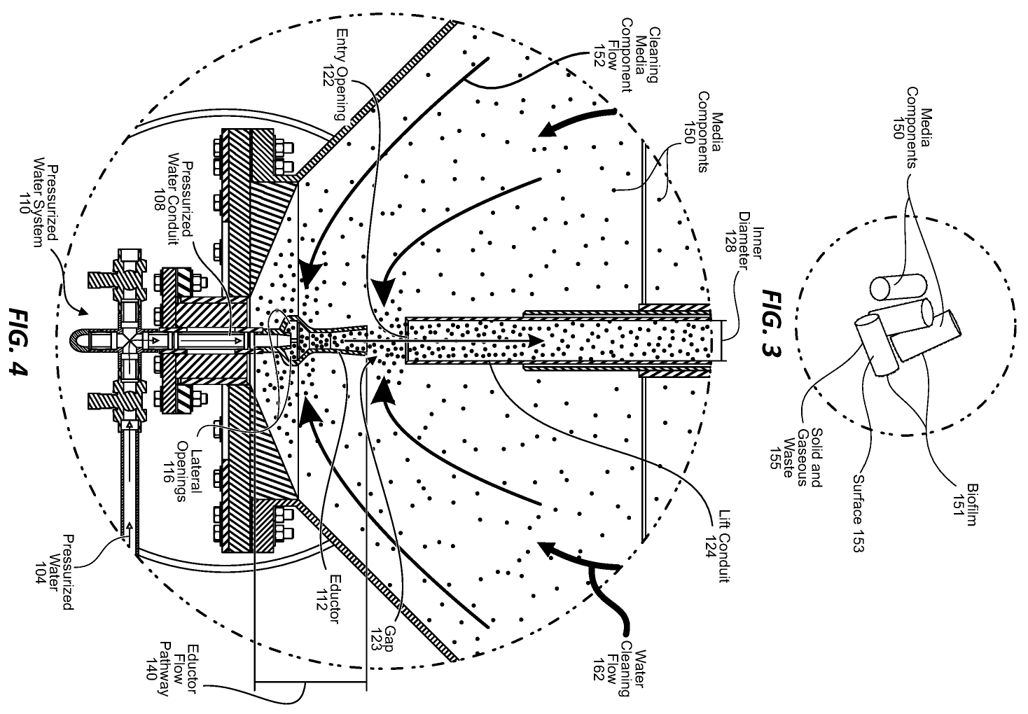

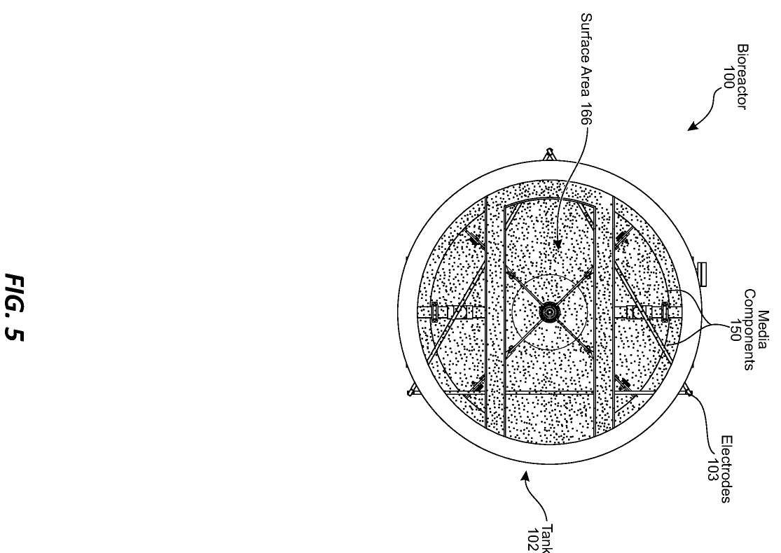

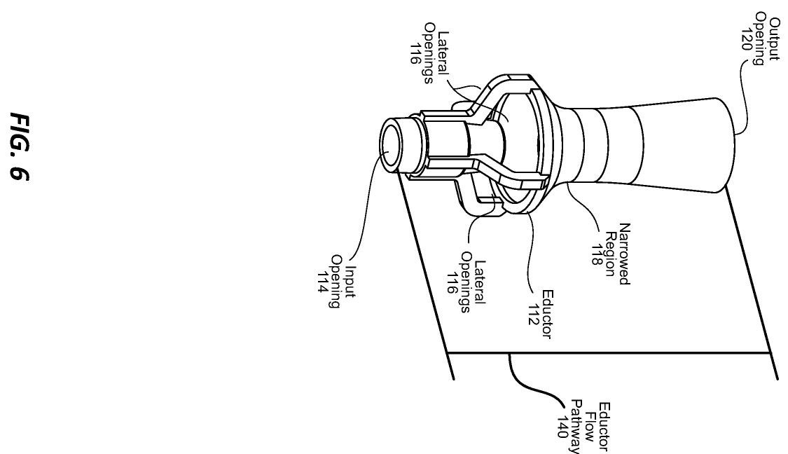

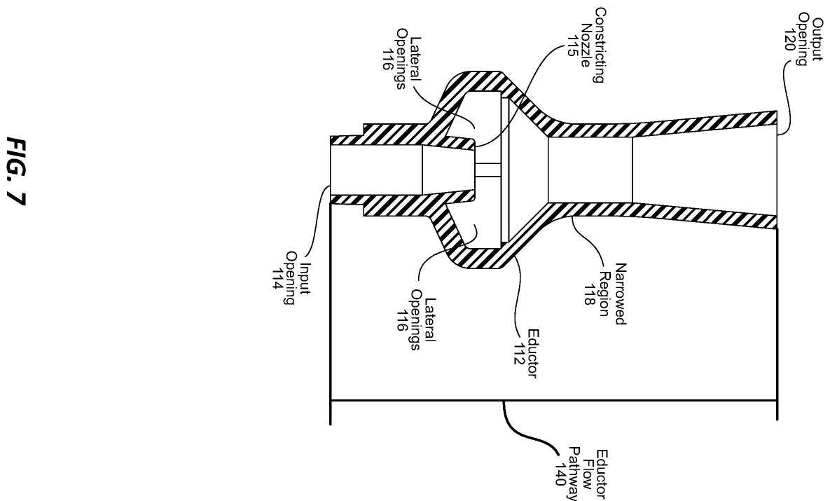

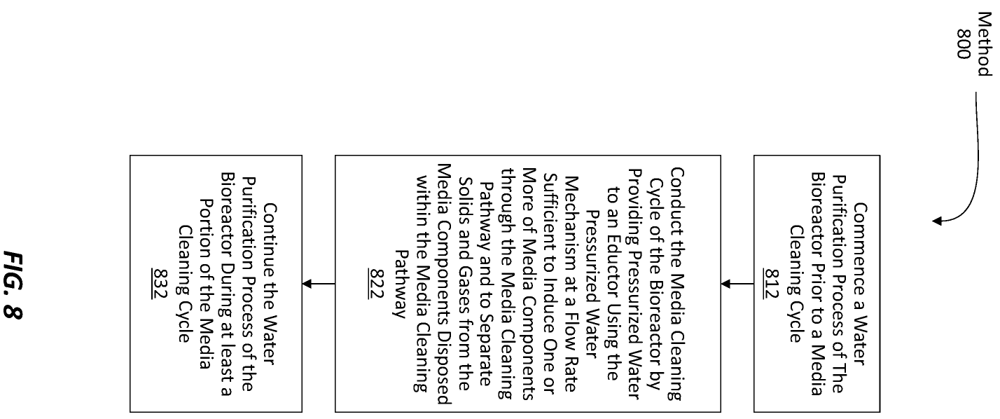

Referring now to FIGS. 1-7, FIG. 1 is a side view of one embodiment of a bioreactor 100 disposed on an influencing gravitational source 106; FIG. 2 is a cross-sectional view of the bioreactor 100 of FIG. 1 with the pressurized water source 101 omitted; FIG. 3 is an enlarged view of region 3 of FIG. 2, which illustrates media components 150 and biofilm 151; FIG. 4 is an enlarged view of region 4 of the bioreactor 100 depicted in FIG. 2, which illustrates the eductor 112 and an optional gap 123 between the eductor 112 and the lift conduit 124; FIG. 5 is a top view of a portion of the bioreactor 100 shown in FIG. 2 with certain portions omitted to better illustrate a surface area 166 of the media components 150 disposed within the tank; FIG. 6 is a bottom perspective view of one embodiment of an eductor 112 that may be utilized in connection with a bioreactor 100; and FIG. 7 is a side cross-sectional view of the eductor 112 of FIG. 6.

The bioreactor 100 illustrated in these figures provides only one example of potential bioreactors that may incorporate one or more of the features of the disclosed subject matter. For example, the bioreactor 100 may utilize microbes that thrive in anoxic (no oxygen is present), anaerobic (an absence of free oxygen), and/or aerobic (involving free oxygen) conditions for purification of water 160. Also, the precise shape and orientation of various features and components of the bioreactor 100 may be configured in a number of different ways beyond those illustrated in the figures and as discussed herein, as will be understood by those skilled in the art once enlightened by the teachings provided.

The bioreactor 100 may include a tank 102. The tank 102 may include a remote end 138, through which the purified water 160 exits the bioreactor 100, and a convergence end 132. A convergence region 130 is disposed adjacent to the convergence end 132. The convergence region 130 is a narrowing portion of the tank 102 that directs water 160 and media components 150 toward the eductor 112. When in an installed configuration, as illustrated in FIG. 1, the convergence end 132 is disposed closer to the influencing gravitational source 106 (e.g., the earth) than the remote end 138. The remote end 138 is an end of the tank 102 remotely positioned relative to the influencing gravitational source 106.

The eductor 112 and the lift conduit 124 work in a cooperative manner to clean the media components 150 within a media cleaning pathway 142, as will be discussed in further detail below. The media components 150 disposed within the tank 102 each comprise at least one surface 153 for receiving a biofilm 151 for purification of water 160. The media components 150 may comprise, for example, activated carbon or small-grain sand. The biofilm 151 is composed of microbes and/or associated enzymes that transform undesirable components found within the water 160. In the process of transforming undesirable components within the water 160, the microbes produce solid and gaseous waste 155 (e.g., biomass and carbon dioxide). Over time, the solid and gaseous waste 155 can accumulate within the tank 102 adhering to the media components 150, thereby impeding the efficient operation of the bioreactor 100 in connection with the purification of water 160.

To aid in cleaning the media components 150, the bioreactor 100 may also include a pressurized water system 110, which may include a pressurized water source 101 and a pressurized water conduit 108 positioned to provide pressurized water 104 to the eductor 112 (and more specifically to the input opening 114 of the eductor 112). The pressurized water source 101 may comprise, for example, a pump and/or an elevated water container.

The eductor 112 is a component using a driving fluid, pressurized water 104, that passes through a constricted area (e.g., a narrowed region 118) to create a low-pressure zone, which draws in water 160 and media components 150 into the eductor 112, based on the Venturi effect. In various embodiments, the eductor 112 may be disposed at least partially within the convergence region 130. The eductor 112 may comprise an input opening 114, an output opening 120, an eductor flow pathway 140, one or more lateral openings 116, and a narrowed region 118 disposed within the eductor flow pathway 140 between the lateral openings 116 and the output opening 120. The input opening 114 and the output opening 120 may be disposed at opposite ends of the eductor flow pathway 140. The input opening 114, the output opening 120, the eductor flow pathway 140 and the lateral openings 116 may be in fluid communication with each other. The lateral openings 116 may be disposed intermediate the input opening 114 and the narrowed region 118 along the eductor flow pathway 140. The narrowed region 118 may be disposed intermediate the lateral openings 116 and the output opening 120 along the eductor flow pathway 140. The one or more lateral openings 116, the narrowed region 118, and the output opening 120 may be of sufficient size to allow the water 160 and the media components 150 to pass through each of these components 116, 118, 120. The eductor 112 may also comprise a constricting nozzle 115 disposed between the input opening 114 and the narrowed region 118, as illustrated in FIG. 7.

The lift conduit 124 may have an entry opening 122, an exit opening 126, and a lift conduit pathway 144 placing the entry opening 122 and exit opening 126 in fluid communication. The entry opening 122 may be disposed to receive the pressurized water 104 and media components 150 exiting from the output opening 120 of the eductor 112.

In various embodiments, the media cleaning pathway 142 may extend from the one or more lateral openings 116 in the eductor 112, along the eductor flow pathway 140, through the output opening 120 of the eductor 112, into the entry opening 122 of the lift conduit 124, through the lift conduit pathway 144, and to the exit opening 126 of the lift conduit 124.

Also, a gap 123, if present between the eductor 112 and the lift conduit 124, may comprise a portion of the media cleaning pathway 142. In various embodiments, the water 160 and media components 150 may be induced through the gap 123 and into and up through the lift conduit 124 as a result of the eductor 112. The solid and gaseous waste 155 is separated from the media components 150 within the media cleaning pathway 142. Thus, the eductor 112, working in conjunction with the convergence region 130, induces the media components 150 to circulate through the media cleaning pathway 142, cleaning the media components 150.

The media components 150 may be induced towards the eductor 112 by the influencing gravitational source 106 and vacuum effect of the eductor 112, guided by the inwardly inclined walls of the convergence region 130, in accordance with the cleaning media component flow 152. The pressurized water system 110, eductor 112, and lift conduit 124 provide a highly effective system for separating the solid and gaseous waste 155 from the media components 150 within the media cleaning pathway 142. Moreover, this separation process is confined to the media cleaning pathway 142, which extends through a portion of the eductor 112, through an optional gap 123 (if present) between the eductor 112 and the lift conduit 124, and through the lift conduit 124. Within the media cleaning pathway 142, at least some of the media components 150 are fluidized, which signifies that the media components 150 are subjected to fluid flow rate such that the media components 150 behave as though they were a fluid. In various embodiments, outside of the media cleaning pathway 142, no fluidizing of the media components 150 takes place. Thus, the terms “fluidization” or “fluidizing” signify that the media components 150 are subjected to fluid flow rate such that the media components 150 behave as though they were a fluid.

This is significant because conventional systems and methods involve the injection of high-pressure air and water to separate the solid and gaseous waste 155 from the media components 150 during a media cleaning cycle. This high-pressure air and water disturb the biofilm and additionally require a termination or pausing of the water purification process of a bioreactor, thereby impeding ongoing operation of the bioreactor. In addition, the disturbance of the biofilm mitigates its effectiveness at least for a period of time, requiring a recovery time after the cleaning process before satisfactory performance is achieved. The high-pressure backwashing of conventional systems also destroys the bed stratification, in which various functional microbial populations are located. In anaerobic and anoxic systems, the pressurized air introduced through backwashing inhibits the anaerobic/anoxic microbial processes, further delaying satisfactory operation of the bioreactor.

Thus, the bioreactor 100 disclosed herein provides a number of advantages over conventional systems and methods. The pressurized water 104 is provided at a lower pressure than other systems, which results in a decreased disturbance of the biofilm 151 on the media components 150. In various embodiments of the disclosed systems and methods, the bioreactor 100 does not involve the introduction of pressurized air during media cleaning cycles, which is employed in conventional media cleaning cycles and inhibits the microbial processes.

Furthermore, within various embodiments of the systems and methods disclosed herein, the separation of the solid and gaseous waste 155 from the media components 150 may be confined to the media cleaning pathway 142, which, again, limits the disturbance of the biofilm 151, which results in a more effective transformation of undesirable components within the water 160. Thus, in various embodiments, a pressurized water source 101 (which may comprise, for example, a pump and/or a water source or tower) may be configured to provide the pressurized water 104 via the pressurized water conduit 108 to the eductor 112 at a flow rate sufficient to induce one or more of the media components 150 through the media cleaning pathway 142 and to separate solids and gases from the media components 150 disposed within the media cleaning pathway 142 without fluidizing the media components 150 outside of the media cleaning pathway 142 during a media cleaning cycle of the bioreactor 100. All of this may be achieved without injecting pressurized air into the tank 102 during a media cleaning cycle of the bioreactor 100 in various embodiments. The systems and methods disclosed herein may utilize the injection of pressurized water 104, which may include some dissolved air, but are distinguishable from the injection of pressurized air utilized in conventional systems and methods. As indicated previously, the injection of pressurized air utilized in conventional systems and methods exposes the microbes to high levels of oxygen, which inhibits the microbial processes of anaerobic and anoxic microbes. Even if the pressurized water 104 in the disclosed systems and methods includes dissolved oxygen at a saturation point of about 8 to 13 milligrams per liter of water, the dissolved oxygen is de minimis in quantity and will not have a significant, adverse impact on anaerobic or anoxic microbes.

In various embodiments, the flow rate is greater than or equal to 1 gallon per minute and less than or equal to 60 gallons per minute, which is well below the flow rate utilized during cleaning by conventional systems and methods. Also, in various embodiments, the flow rate is greater than or equal to 0.1 gallons per minute and less than or equal to 1.5 gallons per minute per square foot of surface area 166 of the media components 150 in the tank 102. It should be noted that, for the sake of clarity and simplicity of illustration, the media components 150 are illustrated in FIGS. 2 and 4 as being dispersed throughout the tank 102 with substantial intervening spaces. However, in various embodiments, the media components 150 may fill the entire space within the tank 102 in a mutually abutting manner, noting that there will be some gaps between the media components 150 even in this state because each media component 150 is not shaped and oriented to be perfectly flush with surrounding media components 150. Thus, the surface area 166 of the media components 150 may be roughly equivalent to the surface area of the water 160 within the tank 102 (which should be distinguished from an aggregated surface area of each individual media component 150).

In various embodiments, depending on the desired cleaning flow rate of the bioreactor 100, for example, an inner diameter 128 of the lift conduit 124 may be greater than or equal to 1 inch and less than or equal to 6 inches.

A media cleaning cycle of the bioreactor 100 refers to a period of time during which cleaning of the media components 150 takes place. Therefore, this refers to a period of time when the eductor 112 is operating to induce water 160 and media components 150 through the media cleaning pathway 142. A media cleaning cycle may take place at regular intervals (e.g., 4 times per hour and 1-minute durations or 2 times per day and 5-minute durations).

One advantage of the disclosed systems and methods is that the water purification process of the bioreactor 100 is not disrupted, interrupted, or paused by the media cleaning cycle. Stated differently, the media cleaning cycle(s) can take place concurrently with the water purification process of the bioreactor 100. Conventional systems do not allow this and require a termination or pausing of the water purification process of the bioreactor 100 during a media cleaning cycle. Therefore, in various embodiments, a water purification process of the bioreactor 100 continues through at least a portion of the media cleaning cycle of the bioreactor 100.

The water purification process of the bioreactor 100 involves moving the water 160 to be purified through the media components 152 and out through the remote end 138 of the tank 102, thus enabling the biofilm 151 to act upon and remove the target contaminants from the water 160. As a consequence, the bioreactor 100 may also comprise a water influent system 133, which may include one or more distribution headers 134, for introducing water 160 to be purified into the tank 102. In various embodiments, at least one distribution header 134 is disposed closer to the convergence end 132 than the remote end 138. The water 160 to be purified may flow upward, away from the influencing gravitational source 106, in accordance with the cleaning water flow 162. As stated above, as the water 160 flows through the media components 150 and the biofilm 151, the biofilm 151 transforms target undesirable components within the water 160.

The water purification process may involve, by way of example only, removing oxyanions, such as nitrate/nitrite and selenite/selenite, from contaminated water 160, including ground waters, surface waters, municipal wastewater, mining process waters, and mine seepage waters.

In various embodiments, electrodes 103 may be included as a portion of the bioreactor 100, as discussed in U.S. Pat. No. 9,499,423, which is incorporated herein in its entirety. U.S. Pat. No. 9,499,423 discloses, providing freely available electrons using electrodes 103 to enhance the effectiveness of the microbes and/or enzymes that comprise a portion of the biofilm 151.

The disclosed systems and methods also provide an additional advantage in that the removal of spent media components 150 is facilitated. Generally, when the media is spent, extensive efforts are needed to extract the spent media from a bioreactor tank, including hiring a vacuum truck for extraction of the spent media. In the disclosed systems and methods, the spent media components 150 may be extracted by simply attaching a hose to the exit opening 126 of the lift conduit 124 and supplying pressurized water 104 to the eductor 112.

As used herein, the term an “anaerobic/anoxic fixed film bioreactor” refers to a bioreactor that utilizes anaerobic and/or anoxic microbes comprising a biofilm on media components to purify water.

Description of FIG. 8

FIG. 8 illustrates a method 800 of operating a bioreactor, which may include one or more of the components of the bioreactor 100 discussed in connection with FIGS. 1-7.

For example, the bioreactor 100 may comprise a fixed film bioreactor 100 for purification of water 160. The bioreactor 100 may comprise an anaerobic/anoxic bioreactor 100 that may employ anoxic and/or anaerobic microbes for purification of water 160. The bioreactor 100 may comprise a tank 102 having a remote end 138 and a convergence region 130. Media components 150 may be disposed within the tank 102. Each media component 150 may comprise at least one surface 153 for receiving a biofilm 151 for purification of the water 160. An eductor 112 may be disposed at least partially within the convergence region 130. A lift conduit 124 may be configured to receive pressurized water 104, and media components 150 from the eductor 112. A media cleaning pathway 142 may extend through at least a portion of the eductor 112 and through the lift conduit 124. A pressurized water source 104 may be configured to provide pressurized water to the eductor 112. In summary, the method 800 may utilize a bioreactor 100 incorporating one or more of the components disclosed in connection with FIGS. 1-7, including, for example, a pressurized water source 101, an eductor 112, and a lift conduit 124.

The method 800 of operating the bioreactor 100 may comprise commencing 812 a water purification process of the bioreactor 100 prior to a media cleaning cycle. This step may involve providing water 160 to be purified into the tank 102 utilizing, for example, a water influent system 133 comprising one or more distribution headers 134. This step may additionally include some preparatory work, such as developing the biofilm 151 to achieve satisfactory water purification.

A media cleaning cycle of the bioreactor 100 may be conducted 822 by providing pressurized water 104 to an eductor 112 using the pressurized water source 101 at a flow rate sufficient to induce one or more of the media components 150 through the media cleaning pathway 142 and to separate solids and gases from media components 150 disposed within the media cleaning pathway 142 without fluidizing media components 150 outside of the media cleaning pathway 142 and without injecting pressurized air into the tank 102 during the media cleaning cycle of the bioreactor 100. In some embodiments, the flow rate may be greater than or equal to 1 gallon per minute and less than or equal to 60 gallons per minute. As indicated previously, in various embodiments, the flow rate may be greater than or equal to 0.1 gallons per minute and less than or equal to 1.5 gallons per minute per square foot of surface area 166 of the media components 150 in the tank 102, as previously defined. In addition, in various embodiments, an inner diameter 128 of the lift conduit 125 is greater than or equal to 1 inch and less than or equal to 6 inches. Also, there may be an optional gap 123 between the eductor 112 and the lift conduit 124 that is sufficiently large to allow media components 150 to pass through the gap 123 and into an entry opening 122 of the lift conduit 124.

The method 800 may further comprise continuing 832 the water purification process of the bioreactor 100 during at least a portion of the media cleaning cycle. Thus, the water purification process of the bioreactor 100 is not interrupted or paused to conduct 822 the media cleaning cycle utilizing the systems and methods disclosed herein.

### CONCLUSION

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods, systems and components of the matter disclosed herein without departing from the spirit and scope of the invention, in addition to the variations of the methods and apparatuses disclosed previously. For example, the eductor 112 may be configured in various ways within the scope of the disclosed subject matter so long as it utilizes the Venturi effect to induce media components 150 and water 160 through the eductor 112 and into and through the lift conduit 124. Also, the particular shape of the tank 102 may be varied within the scope of the disclosed subject matter. For example, the entire tank 102 or a larger portion of the tank 102 could be conical in shape to induce media components 150 toward the eductor 112. The lift conduit 124 and eductor 112, as illustrated in the figures, is oriented in a vertical position when the bioreactor 100 is in an installed configuration, as illustrated in FIG. 1. However, the lift conduit 124 and/or eductor 112 could be situated at different angles, such as at a 75° or 80° angle relative to a surface of the influencing gravitational source 106. Also, again by way of example only, the size of the gap 123 may be varied or omitted entirely. The bioreactor 100 illustrated in the figures is an upflow bioreactor 100, meaning that the water 106 to be purified flows upward through the bioreactor 100 away from the influencing gravitational source 106. However, the disclosed systems and methods, specifically including the pressurized water system 110, an eductor 112 and a lift conduit 124 for cleaning the media components 150, could be implemented within a downflow bioreactor, in which the water 106 to be purified flows downward toward the influencing gravitational source 106. When implemented in connection with a downflow bioreactor, the purified water would flow downward through the media components (with the water being purified by the biofilm 151) and exit the tank at a location at or near the convergence end 132 or convergence region 130. The values and analysis presented therein are presented in the Imperial system (e.g., US customary system) but should not be limited to this type of analysis and could be formulated based on the metric system. It should be noted that the specifically cited variations in alterations serve only as examples. Again, those skilled in the art may appreciate that the disclosed subject matter is only illustrative of the pertinent principles and components.

1. An anaerobic/anoxic fixed film bioreactor for purification of water, the bioreactor configured to provide media cleaning, comprising:
a tank comprising a convergence end and a remote end, wherein, when the bioreactor is in an installed configuration, the convergence end is disposed closer to an influencing gravitational source than the remote end, the tank comprising a convergence region disposed at the convergence end;
a water influent system comprising at least one distribution header for introducing water to be purified into the tank, wherein the at least one distribution header is disposed closer to the convergence end than the remote;
media components disposed within the tank, each of the media components comprising at least one surface for receiving a biofilm for purification of the water;
an eductor disposed at least partially within the convergence region, the eductor comprising an input opening, an output opening, an eductor flow pathway, one or more lateral openings, and a narrowed region disposed within the eductor flow pathway between the lateral openings and the output opening, the input opening and the output opening being disposed at opposite ends of the eductor flow pathway with the input opening, the output opening, the eductor flow pathway and the lateral openings in fluid communication with each other, the lateral openings being disposed intermediate the input opening and the narrowed region along the eductor flow pathway, wherein the one or more lateral openings, the narrowed region, and the output opening are of sufficient size to allow the water and the media components to pass therethrough;
a pressurized water conduit positioned to provide pressurized water into the input opening of the eductor;
a lift conduit having an entry opening, an exit opening and a lift conduit pathway placing the entry opening and exit opening in fluid communication with each other, the entry opening disposed to receive the pressurized water and the media components exiting from the output opening of the eductor, wherein a media cleaning pathway extends from the one or more lateral openings, along the eductor flow pathway, through the output opening, into the entry opening, through the lift conduit pathway, and to the exit opening of the lift conduit; and
a pressurized water mechanism configured to provide the pressurized water via the pressurized water conduit to the eductor at a flow rate sufficient to induce one or more of the media components through the media cleaning pathway and to separate solids and gases from the media components disposed within the media cleaning pathway without fluidizing the media components outside of the media cleaning pathway during a media cleaning cycle of the bioreactor, wherein a water purification process of the bioreactor continues through at least a portion of the media cleaning cycle of the bioreactor.

2. The bioreactor of claim 1, wherein pressurized air is not injected into the tank during the media cleaning cycle of the bioreactor.

3. The bioreactor of claim 2, wherein the flow rate is greater than or equal to 1 gallon per minute and less than or equal to 60 gallons per minute.

4. The bioreactor of claim 2, wherein the flow rate is greater than or equal to 0.1 gallons per minute and less than or equal to 1.5 gallons per minute per square foot of surface area of the media components in the tank.

5. The bioreactor of claim 4, wherein an inner diameter of the lift conduit is greater than or equal to 1 inch and less than or equal to 6 inches.

6. The bioreactor of claim 5, wherein the eductor comprises a constricting nozzle disposed between the input opening and the narrowed region.

7. The bioreactor of claim 6, wherein there is a gap between the eductor and the lift conduit, wherein the gap is sufficiently large to allow the media components to pass through the gap and into the entry opening of the lift conduit, the gap comprising a portion of the media cleaning pathway.

8. The bioreactor of claim 7, wherein the media components are selected from a group consisting of activated carbon and small grain sand.

9. A fixed film bioreactor for purification of water, the bioreactor configured to provide media cleaning, comprising:
a tank comprising a convergence end and a remote end, wherein, when the bioreactor is in an installed configuration, the convergence end is disposed closer to an influencing gravitational source than the remote end, the tank comprising a convergence region disposed at the convergence end;
media components disposed within the tank, each of the media components comprising at least one surface for receiving a biofilm for purification of the water;
an eductor disposed at least partially within the convergence region, the eductor comprising an input opening, an output opening, an eductor flow pathway, one or more lateral openings, and a narrowed region disposed within the eductor flow pathway between the lateral openings and the output opening, the input opening and the output opening being disposed at opposite ends of the eductor flow pathway with the input opening, the output opening, the eductor flow pathway and the lateral openings in fluid communication with each other, the lateral openings being disposed intermediate the input opening and the narrowed region along the eductor flow pathway, wherein the one or more lateral openings, the narrowed region, and the output opening are of sufficient size to allow the water and the media components to pass therethrough;
a pressurized water conduit positioned to provide pressurized water into the input opening of the eductor;
a lift conduit having an entry opening, an exit opening and a lift conduit pathway placing the entry opening and exit opening in fluid communication with each other, the entry opening disposed to receive the pressurized water and media components exiting from the output opening of the eductor, wherein a media cleaning pathway extends from the one or more lateral openings, along the eductor flow pathway, through the output opening, into the entry opening, through the lift conduit pathway, and to the exit opening of the lift conduit; and
a pressurized water mechanism configured to provide the pressurized water via the pressurized water conduit to the eductor at a flow rate sufficient to induce one or more of the media components through the media cleaning pathway and separate solids and gases from the media components disposed within the media cleaning pathway without fluidizing the media components outside of the media cleaning pathway during a media cleaning cycle of the bioreactor, wherein a water purification process of the bioreactor continues through at least a portion of the media cleaning cycle of the bioreactor.

10. The bioreactor of claim 9, wherein pressurized air is not injected into the tank during the media cleaning cycle of the bioreactor.

11. The bioreactor of claim 9, wherein the flow rate is greater than or equal to 1 gallon per minute and less than or equal to 60 gallons per minute.

12. The bioreactor of claim 9, wherein the flow rate is greater than or equal to 0.1 gallons per minute and less than or equal to 1.5 gallons per minute per square foot of surface area of media components in the tank.

13. The bioreactor of claim 12, wherein an inner diameter of the lift conduit is greater than or equal to 1 inch and less than or equal to 6 inches.

14. The bioreactor of claim 13, wherein there is a gap between the eductor and the lift conduit, wherein the gap is sufficiently large to allow the media components to pass through the gap and into the entry opening of the lift conduit, the gap comprising a portion of the media cleaning pathway.

15. A method of operating a fixed film bioreactor for purification of water, the bioreactor comprising a tank comprising a remote end and a convergence region, media components disposed within the tank, each media component comprising at least one surface for receiving a biofilm for purification of the water, an eductor disposed at least partially within the convergence region, a lift conduit configured to receive pressurized water and media components from the eductor, a media cleaning pathway extending through at least a portion of the eductor and through the lift conduit, a pressurized water mechanism configured to provide pressurized water to the eductor, the method comprising:
commencing a water purification process of the bioreactor prior to a media cleaning cycle;
conducting the media cleaning cycle of the bioreactor by providing pressurized water to the eductor using the pressurized water mechanism at a flow rate sufficient to induce one or more of the media components through the media cleaning pathway and to separate solids and gases from the media components disposed within the media cleaning pathway without fluidizing the media components outside of the media cleaning pathway, wherein pressurized air is not injected into the tank during the media cleaning cycle of the bioreactor; and
continuing the water purification process of the bioreactor through at least a portion of the media cleaning cycle.

16. The method of claim 15, wherein the flow rate is greater than or equal to 1 gallon per minute and less than or equal to 60 gallons per minute.

17. The method of claim 15, wherein the flow rate is greater than or equal to 0.1 gallons per minute and less than or equal to 1.5 gallons per minute per square foot of surface area of the media components in the tank.

18. The method of claim 17, wherein an inner diameter of the lift conduit is greater than or equal to 1 inch and less than or equal to 6 inches.

19. The method of claim 18, wherein there is a gap between the eductor and the lift conduit, wherein the gap is sufficiently large to allow the media components to pass through the gap and into an entry opening of the lift conduit, the gap comprising a portion of the media cleaning pathway.

20. The method of claim 19, wherein the media components are selected from a group consisting of activated carbon and small grain sand.
